(19) United States
(12) Patent Application Publication
(10) Pub. No.: US 2024/0089514 A1
(43) Pub. Date: Mar. 14, 2024

(54) SYSTEM FOR GENERATING AND PROVIDING A LIVESTREAM

(71) Applicant: BXB ELECTRONICS CO., LTD., Kaohsiung City (TW)

(72) Inventor: Chih-Lin HUNG, Kaohsiung City (TW)

(21) Appl. No.: 18/462,932

(22) Filed: Sep. 7, 2023

(30) Foreign Application Priority Data
Sep. 8, 2022 (TW) 111134076

(51) Int. Cl. H04N 21/2187; H04N 21/262; H04N 21/4223; H04N 21/436; H04N 21/643; H04N 21/854

(52) U.S. Cl. CPC H04N 21/2187; H04N 21/26258; H04N 21/4223; H04N 21/436; H04N 21/643; H04N 21/85406

(57) ABSTRACT

A system for generating and providing a livestream includes a streaming-end assembly configured to generate a data stream, and a streaming server connected to the streaming-end assembly. In response to receipt of the data stream, the streaming server executing a processing software application processes the data stream to generate a plurality of streaming data chunks, and an index file that indicates an order of the plurality of streaming data chunks. The streaming server publishes the streaming data chunks and the index file to an InterPlanetary File System (IPFS) system, so as to enable a viewer-end device executing a web browser to communicate with the IPFS system to obtain the index file and the streaming data chunks from the IPFS system, and to play the streaming data chunks in the order indicated by the index file.

### CROSS-REFERENCE TO RELATED APPLICATION

This application claims priority to Taiwanese Invention Patent Application No. 111134076, filed on Sep. 8, 2022, and incorporated by reference herein in its entirety.

### FIELD

The disclosure relates to a system for generating and providing a livestream, particularly to a system for generating and providing a livestream in a decentralized manner.

### BACKGROUND

Currently, due to the advances in the field of computer networks and capacities of data transmissions via the networks (i.e., bandwidths), the field of media streaming (e.g., streaming of audio and/or video files) has been growing rapidly. Generally, media streaming involves a source continuously providing multimedia content to one or more client-end devices.

One application of media streaming is livestreaming, which involves a streamer who uploads multimedia content to a service platform in real time, and viewers viewing the multimedia content from the service platform in real time. As livestreaming is attracting more consumers, the service platform that hosts the livestreaming service may need progressively more network capacities to enable more viewers to simultaneously view the livestream. For example, in some specific protocols (e.g., protocols related to unicast), when 500 people view a specific stream at the same time, a required bandwidth for accommodating the 500 viewers may be 500 times larger than the bandwidth for one viewer.

Additionally, in the case where livestreaming is provided using some specific cloud service platforms (i.e., centralized livestreaming), the content of the multimedia content typically will be subjected to some form of content censorship.

### SUMMARY

Therefore, an object of the disclosure is to provide a system that can alleviate at least one of the drawbacks of the prior art.

According to one embodiment of the disclosure, the system is for generating and providing a livestream, and includes a streaming-end assembly and a streaming server connected to the streaming-end assembly. The streaming-end assembly is associated with a streamer, and includes a web camera and a recording device connected to the web camera. The web camera is configured to capture images, and the recording device is configured to generate a data stream based on the images. The streaming server includes a processor that executes a processing software application.

The processor, in response to receipt of the data stream, processes the data stream to generate a plurality of streaming data chunks, and an index file that indicates an order of the plurality of streaming data chunks. The streaming server publishes the streaming data chunks and the index file to an InterPlanetary File System (IPFS) system, so as to enable a viewer-end device executing a web browser to communicate with the IPFS system to obtain the index file and the streaming data chunks from the IPFS system, and to play the streaming data chunks in the order indicated by the index file.

According to another embodiment of the disclosure, the system for generating and providing a livestream, includes a streaming-end assembly, a streaming server connected to the streaming-end assembly, and an InterPlanetary File System (IPFS) system communicating with the streaming server.

The streaming-end assembly is associated with a streamer, and includes a web camera and a recording device connected to the web camera. The web camera is configured to capture images, and the recording device is configured to generate a data stream based on the images.

The streaming server includes a processor that executes a processing software application. In response to receipt of the data stream, the processor of the streaming server processes the data stream to generate a plurality of streaming data chunks, and an index file that indicates an order of the plurality of streaming data chunks. The streaming server publishes the streaming data chunks and the index file to the IPFS system, so as to enable a viewer-end device executing a web browser to communicate with the IPFS system to obtain the index file and the streaming data chunks from the IPFS system, and to play the streaming data chunks in the order indicated by the index file.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for generating and providing a livestream according to one embodiment of the disclosure.

FIG. 2 is a block diagram illustrating the system for generating and providing a livestream according to one embodiment of the disclosure, showing an alternative configuration.

FIG. 3 is a flow chart illustrating a process of the streaming server processing the data stream as the data stream is being continuously received over time according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

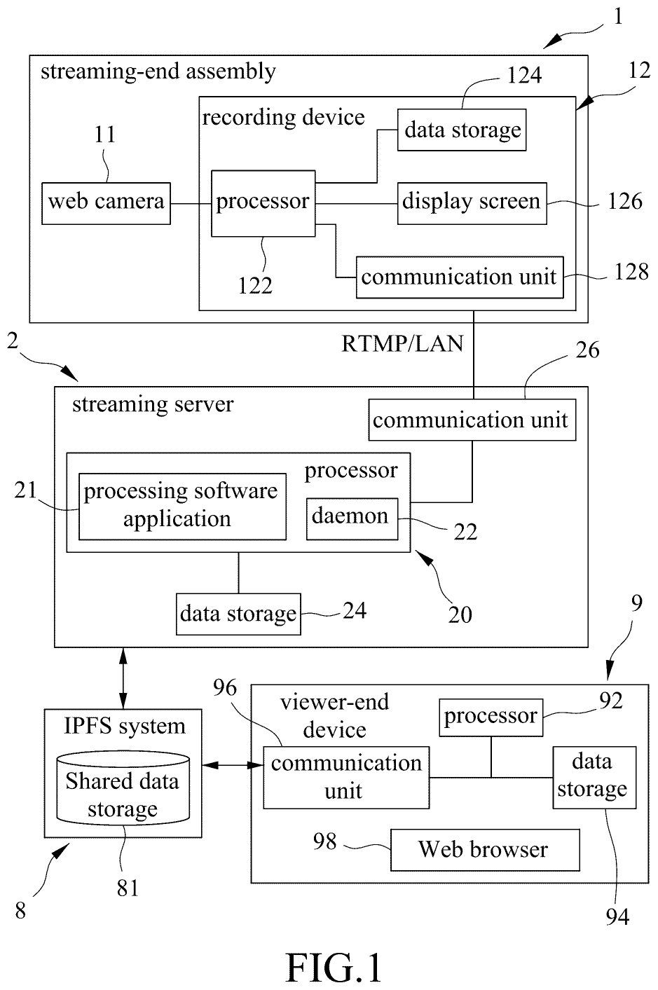

FIG. 1 is a block diagram illustrating a system for generating and providing a livestream according to one embodiment of the disclosure. In this embodiment, the system includes a streaming-end assembly 1 and a streaming server 2. The system may be adapted to be used with an InterPlanetary File System (IPFS) system 8 and a viewer-end device 9.

The streaming-end assembly 1 is associated with a streamer (i.e., a person who records and provides multimedia content), and includes a web camera 11 and a recording device 12.

The web camera 11 is configured to record images, and in some embodiments, the web camera 11 may include an audio recording component for recording audio. In use, the streamer may be located in front of the web camera 11, and the web camera 11 is configured to, when activated, start capturing images. In some embodiments, the audio recording component of the web camera 11 is a built-in microphone for receiving audio input. In some other embodiments, the audio recording component is a separate microphone that is separate from the web camera 11 for receiving audio input.

The recording device 12 is connected to the web camera 11, and may be embodied using an electronic device. In the embodiment of FIG. 1, the recording device 12 may be embodied using a personal computer, a laptop, a tablet, a smartphone or other electronic devices. The recording device 12 includes a processor 122, a data storage 124, a display screen 126 and a communication unit 128.

The processor 122 may include, for example but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage 124 is connected to the processor 122, and may be embodied using, for example, random access memory (RAM), read only memory (ROM), programmable ROM (PROM), firmware, and/or flash memory, etc. The data storage 124 stores a software application including instructions that, when executed by the processor 122, cause the processor 122 to perform operations as described below. In this embodiment, the software application may be an open broadcaster software (OBS). The display screen 126 is connected to the processor 122, and may include one or more of a computer monitor, an electronic visual display, a touch screen, a projection screen, etc.

The communication unit 128 is connected to the processor 122, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or fifth generation (5G) of wireless mobile telecommunications technology, or the like.

In use, the streamer may operate the recording device 12 to execute the OBS, and activate the web camera 11 to start “streaming.” In response, the web camera 11 starts capturing images, and transmits the images to the recording device 12. The processor 122 then generates a data stream based on the images. In the case where the web camera 11 includes a built-in microphone or a separate microphone, the recording device 12 also receives the audio input, and the processor 122 generates the data stream further based on the audio input. In this embodiment, the data stream may be encoded in the form of a Moving Picture Experts Group-4 (MPEG-4) Part 14 (also known as MP4 with the filename extension of .mp4) file, but may also be encoded in other formats in other embodiments.

It is noted that in some cases, the recording device 12 may further record a screencast of the display screen 126 (e.g., a video that is being played on the display screen 126, a game that is being played by the streamer, etc.), and the processor 122 generates the data stream further based on the screencast of the display screen 126 (e.g., combining the images of the streamer and the screencast of the display screen 126).

The streaming-end assembly 1 is connected to the streaming server 2 using Real-Time Messaging Protocol (RTMP) or a web real-time communication (WebRTC) application programming interface (API). In some embodiments, the streaming-end assembly 1 and the streaming server 2 may be located in a same local area network (LAN).

The streaming server 2 may be embodied using a server that operates a web server software such as Nginx, and includes a processor 20, a data storage 24 and a communication unit 26.

The processor 20 may include, for example but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage 24 is connected to the processor 20, and may be embodied using, for example, random access memory (RAM), read only memory (ROM), programmable ROM (PROM), firmware, and/or flash memory, etc. The data storage 24 stores a processing software application 21 and a daemon 22, which is a computer program that runs as a background process. The processing software application 21 includes instructions that, when executed by the processor 20, cause the processor 20 to perform operations as described below. In this embodiment, the processing software application 21 may include fast forward MPEG (FFmpeg), which is an open-source software project for processing multimedia data files. The daemon 22 may be in the form of an IPFS daemon, and enables the streaming server 2 to act as an IPFS node to communicate with the IPFS system 8 that includes multiple other IPFS nodes.

The communication unit 26 is connected to the processor 20, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or fifth generation (5G) of wireless mobile telecommunications technology, or the like. The streaming server 2 is connected to the streaming-end assembly 1 and the IPFS system 8 via the communication unit 26.

In use, the streaming-end assembly 1 is configured to generate the data stream, and to transmit the data stream to the streaming server 2 using the RTMP or the WebRTC API. In some embodiments, the data stream may be in the form of a web media (WebM) file. The transmission may be done periodically (e.g., once every 3-5 seconds).

In response to receipt of the data stream, the processor 20 of the streaming server 2 executing the processing software application 21 (e.g., FFmpeg) processes the data stream so as to create a plurality of streaming data chunks, and an index file that indicates an order of the plurality of streaming data chunks. In other words, using the index file, a web browser is capable of playing the plurality of streaming data chunks in an order indicated by the index file as a continuous multimedia file.

In this embodiment, the streaming data chunks and the index file may be generated to conform with a Hypertext Transfer Protocol (HTTP) live streaming (HLS) protocol. Specifically, the index file may be in the form of Moving Picture Experts Group-1 Audio Layer 3 Uniform Resource Locator (MP3 URL, or M3U) format with a file extension of .m3u8, and the streaming data chunks may be in the form of a transport stream (TS) format with a file extension of .ts.

Afterward, the processor 20 is configured to publish the streaming data chunks and the index file on the IPFS system 8.

The IPFS system 8 may be embodied using a plurality of computing devices that form a peer-to-peer network of nodes, and that may communicate with each other via a network such as the Internet. The computing devices of the IPFS system 8 respectively include physical storage media, such as hard disk drives, that cooperatively form a shared data storage 81 of the IPFS system 8 for storage of the streaming data chunks and the index file (i.e., a distributed file system). While the IPFS system 8 enables the streaming server 2 to read, modify and write the files stored therein, the IPFS system 8 also provides an interface for other external devices to access the content stored therein in a read-only manner. It is noted that the operations of an IPFS system are well known in the related art, and detailed thereof are omitted herein for the sake of brevity.

Specifically, in this embodiment, the processor 20 executing the daemon 22 is configured to control the communication unit 26 to transmit the streaming data chunks and the index file to the IPFS system 8, and to instruct the IPFS system 8 to store the streaming data chunks and the index file in a specific data folder corresponding to this session of streaming.

After the streaming data chunks and the index file are successfully published, the processor 20 obtains an InterPlanetary Name System (IPNS) hash value that indicates a location of the streaming data chunks and the index file. Using the IPNS hash value, other parties may operate an electronic device to open a web browser to locate the streaming data chunks and the index file, and to view the data stream.

In the embodiment of FIG. 1, a viewer who intends to view the data stream may operate the viewer-end device 9 to establish communication with the IPFS system 8. The viewer-end device 9 may be embodied using a personal computer, a laptop, a tablet, a smartphone, or other electronic devices with Internet connection capacities, and includes a processor 92, a data storage 94 and a communication unit 96.

The processor 92, the data storage 94 and the communication unit 96 may be embodied using components that are similar to the processor 122, the data storage 124 and the communication unit 128, respectively, and the processor 92 is configured to execute a web browser 98 for the viewer to operate. In use, the viewer may open the web browser 98 and start to watch streaming content by, for example, visiting an associated website, and the web browser 98 is configured to access the streaming data chunks and the index file stored in the data folder of the IPFS system 8 and play the streaming data chunks in the order indicated by the index file. In some embodiments, the accessing the streaming data chunks and the index file may be conducted based on the HLS protocol. As such, the viewer is enabled to view the streaming data chunks based on the index file, and have the experience of viewing the data stream in a manner similar to a conventional livestream.

One advantage of the configuration is that since the data stream is published on the IPFS system 8 for viewing by multiple viewers, the associated network capacities needed for the streaming server 2 is reduced.

It is noted that in some embodiments, as the streaming continues, additional images/audio input are incorporated into the data stream, and in response to receipt of the data stream, the streaming server 2 may process the data stream to generate additional streaming data chunk(s), and to update the index file to accommodate (i.e., to cover the indication of) the additional streaming data chunk(s). Then, the additional streaming data chunk(s) and the updated index file are published to the shared data storage of the IPFS system 8.

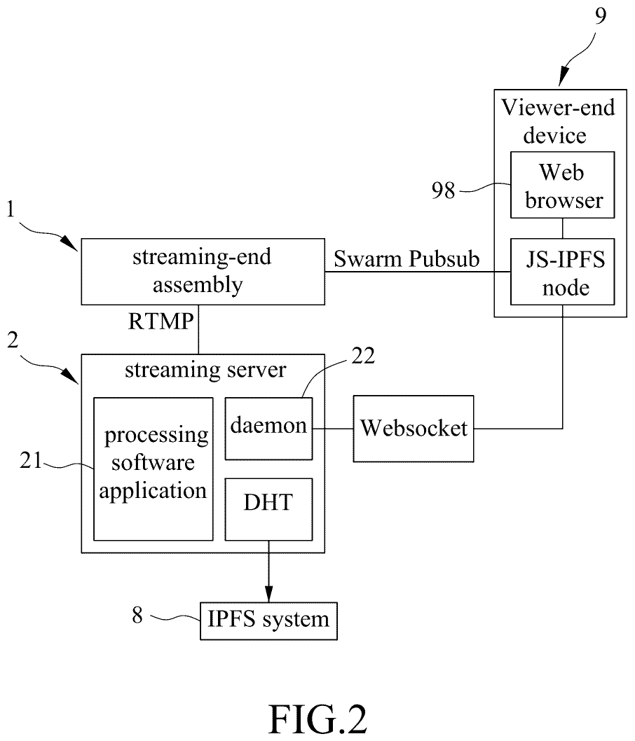

FIG. 2 is a block diagram illustrating the system for generating and providing a livestream according to one embodiment of the disclosure, showing an alternative configuration.

In this configuration, the streaming-end assembly 1 may be in communication with the viewer-end device 9 executing the web browser 98 via a publish-subscribe (PubSub) service under a swarm structure provided in the library peer-to-peer (libp2p) networking framework. Additionally, the viewer-end device 9 executing the web browser 98 may serve as a JS-IPFS (IPFS implementation in JavaScript) node, and communicate with the streaming server 2 executing the daemon 22 (thus acting as an IPFS node) using a WebSocket protocol. After the data stream generated by the streaming-end assembly 1 is received and processed by the processor 20 of the streaming server 2, the resulting streaming data chunks and the index file may be published to the IPFS system 8 using a distributed hash table (DHT) service. Simultaneously, the processor 92 of the viewer-end device 9 may obtain the index file and the streaming data chunks from the streaming server 2 and play the streaming data chunks in the order indicated by the index file.

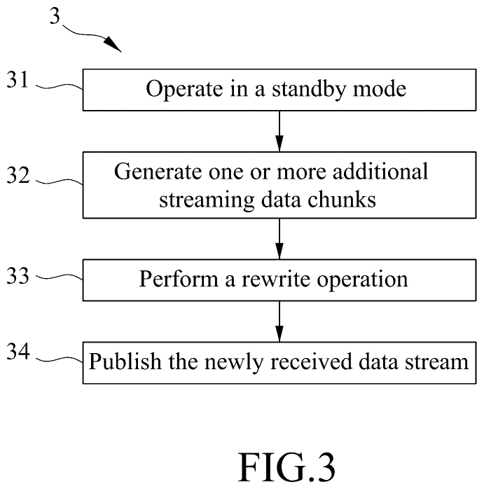

FIG. 3 is a flow chart illustrating a process 3 of the streaming server 2 processing the data stream as the data stream is being continuously received over time according to one embodiment of the disclosure.

In step 31, after the streaming has started, the streaming server 2 operates in a standby mode to wait for transmission of the data stream from the streaming-end assembly 1.

In step 32, in response to receipt of additional data stream (e.g., once every few minutes), the streaming server 2 generates one or more additional streaming data chunks, and transmits the one or more additional streaming data chunks to the IPFS system 8.

In step 33, the streaming server 2 updates the index file to create an updated index file, so as to accommodate the one or more streaming data chunks generated in step 32. In some embodiments, the operation of step 33 may be referred to as a rewrite operation.

Then, in step 34, the streaming server 2 transmits the updated index file to the IPFS system 8, thereby publishing the newly received data stream to the IPFS system 8.

It is noted that the above process 3 is to be implemented periodically (e.g., implementing once every time the additional data stream is received) while the streaming continues. Afterward, in the embodiments of FIG. 1 and FIG. 2, the viewer-end device 9 executing the web browser 98 may communicate with the streaming server 2 or the IPFS system 8 to obtain the streaming data chunks and the updated index file, and therefore the viewer is enabled to view the data stream.

In some embodiments, after the streaming has ended, since the streaming data chunks and the index file have been stored in the shared data storage 81 of the IPFS system 8, the viewers may be enabled to access the data stream after the streaming has ended.

To sum up, the embodiments of the disclosure provide a system that is capable of processing a data stream generated by a streaming-end assembly 1 so as to generate a plurality of streaming data chunks and an index file associated with the streaming data chunks, and to publish the streaming data chunks and the index file to an IPFS system 8. In this manner, distribution of the data stream may be done in a decentralized manner, which may have a number of advantages over the conventional techniques of live streaming. For example, the network capacity needed for the streaming server 2 to accommodate multiple viewers simultaneously viewing the live streaming may be reduced. Additionally, the potential issue of unnecessary censorship associated with the conventional techniques of live streaming may be eliminated using the system as described in the embodiments. Additionally, after the streaming has ended, since the resulting data stream have been stored in the form of streaming data chunks and an index file in a shared data storage of the IPFS system, the viewers may be enabled to access the data stream after the streaming has ended.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

According to one embodiment of the disclosure, there is provided a system for generating and providing a livestream. The system includes a streaming-end assembly, a streaming server connected to the streaming-end assembly, and an InterPlanetary File System (IPFS) system communicating with the streaming server.

The streaming-end assembly is associated with a streamer, and includes a web camera and a recording device connected to the web camera. The web camera is configured to capture images, and the recording device is configured to generate a data stream based on the images.

The streaming server includes a processor that executes a processing software application. The processor of the streaming server, in response to receipt of the data stream, processes the data stream to generate a plurality of streaming data chunks, and an index file that indicates an order of the plurality of streaming data chunks.

The streaming server publishes the streaming data chunks and the index file to the IPFS system, so as to enable a viewer-end device executing a web browser to communicate with the IPFS system to obtain the index file and the streaming data chunks from the IPFS system, and to play the streaming data chunks in the order indicated by the index file.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A system for generating and providing a livestream, comprising:
a streaming-end assembly that is associated with a streamer, and that includes a web camera and a recording device connected to the web camera, the web camera being configured to capture images, and the recording device being configured to generate a data stream based on the images; and
a streaming server connected to the streaming-end assembly, the streaming server including a processor that executes a processing software application,
wherein:
the processor, in response to receipt of the data stream, processes the data stream to generate a plurality of streaming data chunks, and an index file that indicates an order of the plurality of streaming data chunks;
the streaming server publishes the streaming data chunks and the index file to an InterPlanetary File System (IPFS) system, so as to enable a viewer-end device executing a web browser to communicate with the IPFS system to obtain the index file and the streaming data chunks from the IPFS system, and to play the streaming data chunks in the order indicated by the index file.

2. The system as claimed in claim 1, wherein the data stream is encoded in the form of a Moving Picture Experts Group-4 (MPEG)-4 Part 14 file.

3. The system as claimed in claim 1, wherein the streaming-end assembly is connected to the streaming server using Real-Time Messaging Protocol (RTMP).

4. The system as claimed in claim 1, wherein the streaming-end assembly and the streaming server are located in a same local area network (LAN).

5. The system as claimed in claim 1, wherein the processor of the streaming server generates the streaming data chunks and the index file to conform with a Hypertext Transfer Protocol (HTTP) live streaming (HLS) protocol.

6. The system as claimed in claim 5, wherein the index file is in the form of Moving Picture Experts Group-1 Audio Layer 3 Uniform Resource Locator (MP3 URL, or M3U) format with a file extension of .m3u8, and the streaming data chunks are in the form of a transport stream (TS) format with a file extension of .ts.

7. The system as claimed in claim 1, wherein, in response to receipt of additional data stream over time, the processor of the streaming server:
generates one or more additional streaming data chunks to be published to the IPFS system;
updates the index file to create an updated index file, so as to accommodate the one or more streaming data chunks; and
transmits the additional streaming data chunks and the updated index file to the IPFS system.

8. The system as claimed in claim 1, wherein the streaming server is a server device that operates a web server software, and the web server software is Nginx.

9. The system as claimed in claim 1, wherein:
the streaming server includes a daemon in the form of an IPFS daemon that enables the streaming server to act as an IPFS node to communicate with the viewer-end device executing the web browser based on a WebSocket protocol.

10. The system as claimed in claim 1, wherein the recording device executes an open broadcaster software (OBS) to generate the data stream.

11. A system for generating and providing a livestream, comprising:
a streaming-end assembly that is associated with a streamer, and that includes a web camera and a recording device connected to the web camera, the web camera being configured to capture images, and the recording device being configured to generate a data stream based on the images;
a streaming server connected to the streaming-end assembly, the streaming server including a processor that executes a processing software application; and
an InterPlanetary File System (IPFS) system communicating with the streaming server,
wherein:
in response to receipt of the data stream, the processor of the streaming server processes the data stream to generate a plurality of streaming data chunks, and an index file that indicates an order of the plurality of streaming data chunks;
the streaming server publishes the streaming data chunks and the index file to the IPFS system, so as to enable a viewer-end device executing a web browser to communicate with the IPFS system to obtain the index file and the streaming data chunks from the IPFS system, and to play the streaming data chunks in the order indicated by the index file.
